(19) United States
(12) Patent Application Publication
(10) Pub. No.: US 2026/0311902 A1
(43) Pub. Date: Oct. 8, 2026

(54) Electronuclear cogeneration installation with light water reactor (LWR) using a thermal storage cycle connected to a heat network and arranged thermally in parallel with the conversion cycle of the reactor

(71) Applicant: COMMISSARIAT A L'ENERGIE ATOMIQUE ET AUX ENERGIES ALTERNATIVES, Paris (FR)

(72) Inventors: Philippe AMPHOUX, SAINT PAUL LEZ DURANCE (FR); Stephane CATHALAU, SAINT PAUL LEZ DURANCE (FR)

(21) Appl. No.: 19/262,271

(22) Filed: Jul. 8, 2025

(30) Foreign Application Priority Data
Jul. 25, 2024 (FR) 2408233

(51) Int. Cl. G21D 1/02; G21D 1/04; G21D 3/00

(52) U.S. Cl. CPC G21D 1/02; G21D 1/04; G21D 3/001

(57) ABSTRACT

Light water reactor (LWR) electronuclear cogeneration installation with using a thermal storage cycle connected to a heat network and arranged thermally in parallel with the conversion cycle of the reactor. A thermal storage loop thermally in parallel with the secondary circuit of a nuclear reactor.

### TECHNICAL FIELD

The present invention concerns the field of light water nuclear reactors (LWR), notably pressurized water reactors (PWR).

The invention more particularly concerns cogeneration installations including such nuclear reactors. Here, and in the context of the invention, by “cogeneration” is meant the simultaneous or non-simultaneous production of electricity and usable heat.

The main objective of the invention is to improve the economics of a nuclear power station and at the same time to contribute to the decarbonization of the heat market.

Although described with reference to a pressurized water nuclear reactor, the invention applies to any nuclear reactor using an indirect thermodynamic cycle from the family of reactors known as second generation, third generation and fourth generation (GEN IV) reactors. It applies in particular to fast neutron nuclear reactors cooled by liquid metal, notably liquid sodium (SFR (sodium fast reactor)), forming part of the GEN IV family of reactors.

### PRIOR ART

In a context of climate and energy transition, the nuclear industry has to face up to a number of future challenges. Indeed, to address tomorrow's energy and societal challenges it will be opportune to design nuclear reactors that make it possible:
to limit the requirement for so-called “environmental” liquid cold sources (rivers, tidal rivers, sea) and associated rejection into the environment;
to be more flexible and therefore to better complement other so-called renewable energies to address the fluctuating demand for electricity and the intermittent nature of renewable energies;
to decarbonize the methods by supplying heat to consuming industries (desalination, heating networks, hydrogen, chemicals, . . . ) while increasing energy efficiency;
to capture atmospheric CO₂ to limit the effects of global warming and to contribute to closing the carbon cycle by being a source of carbon for industrial processes;
   without this decreasing the cost effectiveness of the installation, either by profiting economically from the new services rendered or by significantly increasing the quantity of electricity produced during the day.

Conventional PWR type reactors are classified according to large families of use:
so-called electricity generation reactors that are dedicated exclusively to the production of electricity;
so-called heat generation reactors that are dedicated exclusively to the production of heat;
so-called cogeneration reactors, dedicated both to the production of heat and the production of electricity, simultaneously or non-simultaneously.

As described in detail in [1], the principle of cogeneration based on a nuclear reactor consists in modifying the design of the energy conversion cycle so that heat is released to the cold source at a temperature that enables its valorization. Indeed, the limitation of climatic heating relies on minimizing heat losses at all levels and in particular at the level of the cold source of a thermodynamic installation. This cogeneration objective becomes all the more pertinent for a nuclear reactor in that industrial or domestic heating is often obtained in the traditional way by burning fossil fuels responsible for the emission of greenhouse gases.

The economics of a nuclear reactor are moreover highly capitalistic and therefore based mostly on amortization of the initial investment in the reactor.

Once the investment has been made it is crucial to seek to operate the reactor at full load approaching its capacities.

Because electricity is not stored on a large scale, purely electricity generation nuclear reactors must track variations of power demand on the grid. They therefore do not operate at all times at 100% of their capacity.

For example the average full power load of a nuclear reactor in the French installed base is 73% whereas its availability at full power is approximately 85%.

Thus there exists unexploited production capacity of the order of 10% to 12% on average.

FIG. 1 shows a load curve of reactors from the French electronuclear installed base situated on different sites (Sites 1, 2, 3) over a few days of operation highlighting load variations and therefore variations in the operation of the reactor between 100% power and the technical minimum of approximately 20% power.

Thus there is a general need to utilize this unexploited capacity to contribute to significantly improving the economics of nuclear reactors at the same time as contributing to decarbonizing the energy system, in particular in the case of cogeneration, that is to say the conjoint production and supply of heat in addition to electricity.

Heat is the prime energy use in France and represents 45% of the final energy consumption (669 TWh in 2020). Decarbonizing the production of this heat, produced at present 60% by fossil fuels, is a major challenge in decarbonizing the French energy mix: [2]. On the world scale, more than 90% of heat is carbon-based: [3].

The heat market can be divided into three large classes each of which is linked to the service rendered [4]:
a first class, “superheated water and steam” at up to approximately 250° C., is the class of heat networks for buildings, industrial requirements for low-temperature steam or processes requiring evaporation (drying, dehydration, etc.);
a second class, “chemical” in which the heat is mainly consumed by the enthalpy of chemical reactions;
a third class, “mineral” in which heat at a temperature greater than approximately 1 000° C. is used to melt solids and/or to drive chemical reactions between solids: lime, cement, sintering ore, production of coke, glassware, iron and steel.

Publication [5] indicates various examples of processes liable to be of concern as a function of the required level of heat:
first class: oil refining, production of oil from bituminous sand and schist, production of pulp and paper, desalination of seawater, urban heating;
second class: direct manufacture of steel, thermochemical production of hydrogen, electrolysis of steam, reforming of methane, petrochemicals (ethylene, styrene);
third class: manufacture of glass and cement.

By using the heat produced by a PWR type reactor, typically at approximately 300° C., or a fast neutron reactor, typically at approximately 550° C., it is therefore possible to contribute to significant decarbonization of industrial systems. It is nevertheless apparent that some applications would require temperatures above 300° C. In this case using nuclear heat could contribute in the form of preheating and additional electricity could notably make it possible to respond to demand. In this case the use of nuclear heat will have contributed to significantly improving overall energy efficiency.

There is therefore a need for further improvement of nuclear cogeneration installations in order to enable the reactor(s) of the installation be operated at the maximum of their full power capacity, even when the grid has not as high a demand as the reactor(s) can produce, and at the same time to respond to the requirements for decarbonization of industrial heat.

The Applicant has already proposed in the patent applications WO2023/078825A1 and FR3128813A1 solutions employing a thermal storage loop in a nuclear installation that make it possible to decorrelate the operation of the nuclear reactor or reactors of the installation from that of the grid that has to adapt to load variations. Thanks to this, the pair consisting of a thermal storage loop and the energy conversion system (Rankine cycle) serves to offset in time the thermal power produced by the nuclear reactor(s) into electrical power to the grid. In other words, the thermal storage loop makes it possible to decorrelate the operation of the reactor where the aim is to cause it to function at its maximum capacities from the demand for electricity on the grid that has to track the load demand.

There has been represented in FIG. 2 an optimum configuration according to the application FR3128813A1 using a pressurized water nuclear reactor (PWR).

The primary circuit 1 is a closed loop fluidic circuit including mainly the core of the reactor 2, at least one steam generator (GV), termed the primary exchanger 3, and a hydraulic pump 4 for circulating the heat transfer fluid, which is water maintained in the liquid state in the operating temperature range of the reactor, typically around 320° C.-330° C. in normal operation. The other equipment, such as a pressurizer and devices enabling operation under the required safety conditions, are not described here.

Thus water at high pressure from the primary circuit takes up energy furnished in the form of heat by fission of the uranium nuclei in the core of the reactor 1.

This water at high pressure and high temperature, typically 155 bar and 320° C.-330° C., then enters the intermediate exchanger 3 and transmits its energy to a secondary circuit 5, also using pressurized water as heat transfer fluid in a closed loop.

This secondary circuit 5 includes the intermediate exchanger 3, the turbine 6 including a high-pressure body 60 and a low-pressure body 61, a condenser 7 and a hydraulic pump 8 for circulating water in the form of steam or liquid water as the heat transfer fluid.

Thus in this secondary circuit 5 water in the form of steam at high pressure, typically at approximately 70 bar, is expanded in the high-pressure body of the turbine and then heated before continuing to expand in the low-pressure body 61. The turbine drives an alternator 9 that produces electricity.

A thermal storage loop 13 is arranged between the primary circuit 1 and the secondary circuit 5 together with a CO₂ capture system with a bypass dry air air-cooling device 20.

The heat storage loop 13 is a closed loop fluidic circuit in which a heat transfer fluid circulates from the intermediate exchanger 3 of the reactor primary circuit to a hot tank 14 and then in a steam generator 16 and in a cold tank 15 in order to return to the intermediate exchanger 3.

The heat transfer fluid is circulated in the loop 13 by a hydraulic pump 17 downstream of the hot tank 14 and a hydraulic pump 18 downstream of the cold tank 18.

The fluidic branches of the loop 13 each consist of a cylindrical section pipe with metal walls resistant to chemical aggression by the heat transfer fluid at high temperatures, typically above 300° C., and thermally insulated externally by means of a high-temperature insulation. The diameter of a pipe is calculated to enable evacuation of all the thermal power with a maximal admissible limit flowrate of the heat transfer fluid, typically of the order of 5 m/s to 10 m/s.

The hot tank 14 enables containment of the heat transfer fluid, storage of all the heat recovered from the intermediate heat exchanger 3 and feeding the steam generator 16 with heat transfer fluid. The hot tank 14 can be of cylindrical shape with walls made of metal resistant to chemical aggression by the heat transfer fluid at high temperatures, typically above 300° C., and is coated with an external high-temperature insulation layer enabling thermal losses to be limited. The dimensions (usable storage volume) of the hot tank 14 depend on the characteristics of the heat transfer fluid used: it must enable storage of at most all the heat produced by the nuclear reactor over a sliding period of 24 hours. For safety reasons the hot tank 14 is typically at a distance estimated beforehand of 60 m from the enclosure of the reactor with a batter between them. The tank 14 can be equipped with a system for heating the heat transfer fluid to guarantee that the fluid remains in the liquid state and/or a level measuring system able to issue an alarm and/or a safety overflow connected directly to the cold tank 15.

The steam generator 16 produces steam for the turbines 60, 61, which is characteristic of a Rankine cycle with the operating modes of an electricity generation cycle of the installation and must be able to operate in accordance with the demand from the grid 21. The steam generator 16 is typically sized to evacuate 1.5 times the power of the nuclear reactor. The turbines 6, 60, 61 are sized on the basis of the peak flowrate of steam produced by the steam generator 16.

Like the hydraulic pump 18, the hydraulic pump 17 is designed to operate at least at the availability coefficient K_{d} of the nuclear reactor and must be able to operate in accordance with fluctuations of the electricity demand of the grid 21 to which the alternator 9 of the nuclear reactor is electrically connected. Given the calorific capacity of the heat transfer fluid and the dimensions of the steam generator 16, the flowrate of the pump 17 or 18 must enable feeding the latter with heat transfer fluid at a flowrate making it possible to respond to the power demand of the grid 21. Each of the pumps 17, 18 has metal walls resistant to chemical aggression by the heat transfer fluid at high temperatures, typically above 300° C. A plurality of pumps 17 or 18 can be positioned in parallel to divide the pumping flowrate and a redundant pump can be provided for safety reasons.

The cold tank 15 has substantially the same heat transfer fluid storage volume as the hot tank 14 for fluid recovered from the steam generator 16. The cold tank 15 can be of cylindrical shape with metal walls resistant to chemical aggression by the heat transfer fluid at high temperatures, typically above 300° C., and is coated with an external high-temperature insulating layer enabling thermal losses to be limited. The dimensions (usable storage volume) of the cold tank 15 depend on the characteristics of the heat transfer fluid used: it must be able to store at most all of the heat produced by the nuclear reactor over a sliding period of 24 hours. For safety reasons the cold tank 15 is typically at a distance estimated beforehand of 60 m from the enclosure of the reactor with a batter between them. The tank 15 can be equipped with a system for heating the heat transfer fluid to guarantee that the fluid remains in the liquid state and/or a level measuring system able to issue an alarm and/or a safety overflow connected directly to the tank 14.

The heat transfer fluid is of the molten salt type so as to remain in the liquid phase over a range of temperatures from 100° C. to 350° C. with a margin of 40° C. relative to the maximum operating temperature. The salt will preferably have the following chemical composition: 53% NaNO₃, 40% NaNO₂, 7% KNO₃ (HITEC® salt).

The total volume of salt contained in the closed loop 13 is equal to the total volume of the cold tank 15 and the volume contained in the fluidic branches/pipes of the loop 13 to prevent any overflow or loading in operation.

The grid 21 connected to the alternator 9 is for transporting and distributing electricity to end users as a function of their requirements. It is a high-voltage grid functioning in accordance with power demands linked to the uses of the electricity and must be able to accept the peak electrical power produced by the cogeneration installation.

This cogeneration installation further includes at least one so-called dry air air-cooling tower 20, that is to say one operating dry, connected in a closed loop to the condenser 7 of the secondary circuit of the reactor. This air-cooling tower 20 transfers heat from the water condensed in the condenser 7 to the surrounding air.

The air-cooling tower 20 is sized to evacuate the thermal power not consumed by the turbines 6, 60, 61 by cooling the water coming from the condenser 7 to the lowest temperature level that the surrounding air can allow through significant heating.

Although not represented, the closed loop including the condenser 7 and the dry air air-cooling tower 20 is equipped with a pumping system for conveying the heat transfer fluid within it, which pumping system can be directly integrated into the tower 20. Operation of the installation with only this air-cooling tower 20 is purely an electricity generation operation with evacuation by means of the dry air air-cooling tower 20 of the residual power not consumed by the electric conversion system 6, 9. In this configuration the installation does not have total energy efficiency but does have the important advantage of producing more electricity during the day than a prior art PWR without necessitating taking in liquid water from the environment or rejecting it into the latter.

In one advantageous configuration the dry air air-cooling tower 20 can bypass an atmospheric CO₂ capture system 22 (direct air capture (DAC) system) or water desalination system.

Thus in the event of the atmospheric CO₂ capture system shutting down the installation functions in the configuration with only the air-cooling tower 20.

Operating in cogeneration mode with supply of low-temperature heat for the atmospheric CO₂ capture system 22 aims to valorize all of the thermal energy of the reactor not used for the production of electricity. The installation can be described as one of total energy efficiency.

In the event of momentary absence of demand for heat for this network the installation returns to the operating configuration with only the air-cooling tower 20.

The whole of the cogeneration installation is typically configured so that there is in the closed loop incorporating the condenser 7 and the atmospheric CO₂ capture system 22 a temperature T1 at the inlet of the condenser of at least 60° C. and a temperature T2 at the outlet of the condenser 7 of at least 70° C. and advantageously between 70° C. and 100° C.

In this installation all the fluid circuits of the nuclear reactor, the thermal storage closed loop, the air-cooling tower and the desalination system are arranged thermally in series.

This thermal series configuration has three major disadvantages, namely:
valorization of the heat to an industrial process at approximately 95° C. for a DAC system or at 70° C. for a desalination system is conditioned by the generation of electricity; the industrial process in series at the terminals of the condenser of the Rankine cycle can function only when the conversion cycle produces electricity and must also function according to the load demand of the grid,
the temperature level of the heat supplied to the industrial process is limited and does not enable heat to be supplied at a very high temperature, that is to say 300° C., at the outlet of the primary circuit because of the conversion into electricity carried out upstream (passage of the steam in the turbines), which limits the maximum temperature levels for the heat transmitted to around one hundred degrees Celsius at the terminals of the condenser, which temperature depends on the operating pressure of the latter, and it is therefore not possible to respond to thermal requirements of industrial processes with a temperature of the order of 300° C.,
the overall electricity generation efficiency of the installation is reduced relative to a reference value of the order of 33% in a purely electricity generation PWR type reactor because of a supplementary exchanger pinch effect generated by locating the thermal storage loop between the reactor and the conversion cycle and a temperature level required to feed the processes at the terminals of the condenser above a classic cold source (seawater or cooling tower water) type temperature.

Consequently, there still exists a need to improve nuclear cogeneration installations in order to enable the reactor(s) of the installation to operate at the maximum capacity at full power even when the grid does not have as much demand as the reactor(s) can produce and to respond to the industrial heat decarbonization requirements and doing this by overcoming some or all of the disadvantages of the installations according to the patent applications WO2023/078825A1 and FR3128813A1.

The object of the present invention is to respond at least partially to this requirement.

### STATEMENT OF INVENTION

To this end, one aspect of the invention concerns an electronuclear cogeneration installation comprising:
at least one nuclear reactor, in particular a pressurized water reactor (PWR) or a boiling water reactor (BWR) comprising:
   a first fluidic circuit, termed the primary circuit, comprising at least one steam generator serving as a first intermediate heat exchanger;
   a second fluidic circuit, termed the secondary circuit, comprising at least one turbine connected to the first intermediate heat exchanger and a first condenser connected to the turbine and to the steam generator to cool the steam from the turbine and to convert it back into water and return it into the steam generator;
   an alternator mechanically coupled to the turbine and intended to be connected to a grid;
a third fluidic circuit configured as a closed thermal energy storage loop in which a heat exchanger fluid circulates, comprising:
   at least one second condenser serving as a second intermediate heat exchanger;
   at least one output heat exchanger connected in a closed loop to an industrial heat network;
   at least one first tank, termed the hot tank, connected to the second condenser;
   at least one first hydraulic pump connected to the hot tank and to the output heat exchanger;
   at least one second tank, termed the cold tank, connected to the output heat exchanger;
   at least one second hydraulic pump connected to the cold tank and to the second condenser;
a fluidic system for connecting thermally in parallel the third fluid circuit and the second fluidic circuit.

In one advantageous embodiment the fluidic system for connecting thermally in parallel the third fluidic circuit and the second fluidic circuit comprises:
a steam distribution and regulation device connected at the input to the steam generator and at the output to the turbine and at the same time to the second condenser;
a water collecting tank connected at the inlet to the first condenser and at the same time to the second condenser and at the outlet to the steam generator;
a third pump connected between the water collecting tank and the steam generator.

In one advantageous variant the steam distribution and regulation device comprises two motorized regulation valves one of which connects the steam generator to the turbine and the other of which connects the steam generator to the second condenser.

Opening and closing the valve connecting the steam generator to the turbine are advantageously controlled in accordance with regulation set points as a function of reactor load tracking whereas opening and closing the valve connecting the steam generator to the second condenser are controlled in accordance with regulation set points as a function of the level in the hot tank.

The temperature of the water in the collecting tank is preferably between 150° C. and 200° C.

The reactor containment vessel and the steam generator are advantageously configured as a small modular reactor (SMR) with at least one atmospheric carbon dioxide CO₂ capture system and/or seawater desalination system connected in a closed loop to the condenser of the secondary circuit of the reactor.

In one advantageous embodiment the installation includes a carbon dioxide CO₂ capture system and/or seawater desalination system or any other cogeneration system with a heat demand compatible with the temperature at the terminals of the condenser, connected in a closed loop to the condenser of the secondary circuit of the reactor. This embodiment enables simultaneously:
operating the reactor at its designed nominal availability coefficient (K_{d}) independently of the power demand of the grid connected to the alternator;
optimal valorization of some or all of the thermal energy produced by the reactor to provide new non-energy services (atmospheric CO₂ capture and/or seawater desalination);
at least partially circumventing a requirement for using liquid water as a cold source and the associated waste to contribute to the process of evacuation of non-valorized energy.

As a corollary to this, it is therefore possible to enhance the safety of the installation by making available a device corresponding to residual power evacuation for periods in which the reactor is shut down.

In one advantageous variant the installation further comprises a dry air air-cooling device connected to bypass a connection to the carbon dioxide CO₂ capture system or seawater desalination system.

In accordance with one advantageous feature the dry air air-cooling device is a dry air air-cooling tower.

The invention essentially consists in using a thermal storage loop thermally in parallel with the secondary circuit of a reactor.

In other words, instead of coupling the circuits of a nuclear reactor and a thermal storage loop in fluidic series as in the patent applications WO2023/078825A1 and FR3128813A1, the thermal storage loop is in parallel with the energy conversion system (Rankine cycle).

The dimensions of the hot and cold tanks of the storage loop depend on the required temperature level. The volume of the tank is advantageously between 1000 m³ and 30 000 m³, the industrial feasibility of such tanks having been already mastered given what is modern practice in other industrial fields.

These dry air air-cooling towers do not need any liquid water for cooling, regardless of the consumer or the demand for heat.

An installation makes it possible to preserve the advantage of not rendering the functioning of the reactor dependent on possible variations of demand, as in the patent applications WO2023/078825A1 and FR3128813A1.

Finally, a nuclear cogeneration installation according to the invention using a PWR type nuclear reactor with a thermal storage loop thermally in parallel with the energy conversion cycle of the reactor has numerous major advantages compared to an installation according to the patent applications WO2023/078825A1 and FR3128813A1, among which can be cited:
not adding an exchanger pinch effect between the primary circuit and energy conversion and therefore not impacting thermodynamic efficiency,
being able to supply heat to industrial processes independently of the demands of the grid,
supplying heat at a temperature much higher than that available at the terminals of the condenser.

In this embodiment the temperature T1 at the inlet of the condenser is preferably at least 60° C. and the temperature T2 at the outlet of the condenser is preferably at least 70° C., advantageously between 70° C. and 100° C.

Each of the hot and cold tanks advantageously has a volume between 1 000 m³ and 30 000 m³ and they need not be situated on the nuclear installation site.

The heat transfer fluid in the thermal storage loop is advantageously a molten salt or a mixture of molten salts adapted to remain in the liquid phase over a range of temperatures from 100° C. to 350° C. with a margin of 40° C. relative to the maximum temperature in operation of the thermal storage loop.

The heat transfer fluid preferably has the following chemical composition:
45% NaNO₂, 7% KNO₃, 48% Ca(NO₃)₂ (HITEC-XL salt).

In one advantageous variant embodiment, the turbine or turbines include(s) no low-pressure bodies.

Other features and advantages of the invention will become more clearly apparent on reading the detailed description of embodiments of the invention given by way of non-limiting illustration with reference to the following figures.

### BRIEF DESCRIPTION OF THE DRAWINGS

FIG. 1 depicts a load curve of reactors of the nuclear electricity generation installed base in France on various sites (Sites 1, 2, 3) over a few days of operation.

FIG. 2 is a schematic view of one configuration of a cogeneration installation according to the patent application FR3128813A1 including a pressurized water reactor (PWR), a thermal storage loop, an atmospheric CO₂ capture system and an air-cooling device employing dry air and bypassing the atmospheric CO₂ capture system.

FIG. 3 is a schematic view of a configuration of a cogeneration installation according to the invention including a pressurized water reactor (PWR), a thermal storage loop thermally in parallel with the conversion system of the reactor, an atmospheric CO₂ capture system and/or an air-cooling device employing dry air and bypassing the atmospheric CO₂ capture system.

FIG. 4 is a load curve of reactors from the nuclear electricity generation installed base in France on different sites (Sites 1, 2, 3), such as could be the case over a few days of operation of the reactor in accordance with the invention.

FIG. 5 is a block schematic depicting one operating mode of an installation according to FIG. 3.

### DETAILED DESCRIPTION

Throughout the present application the terms “upstream” and “downstream” are to be understood as referred to the direction of circulation of a heat transfer fluid in one of the fluidic circuits of a nuclear cogeneration installation according to the invention.

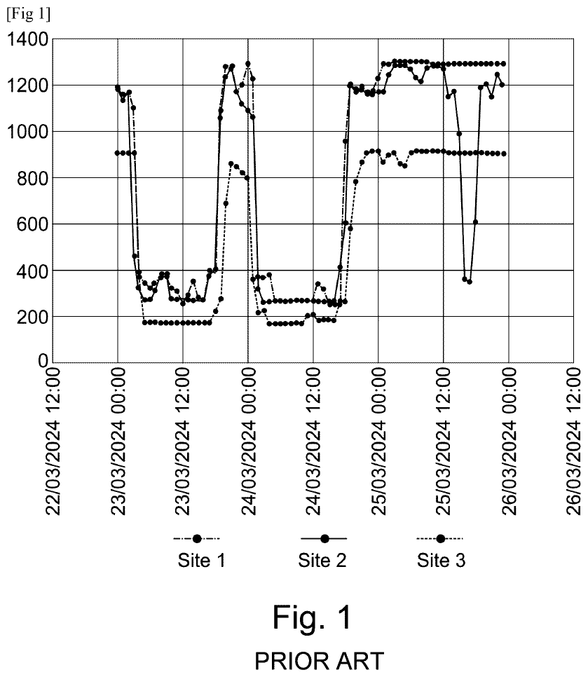

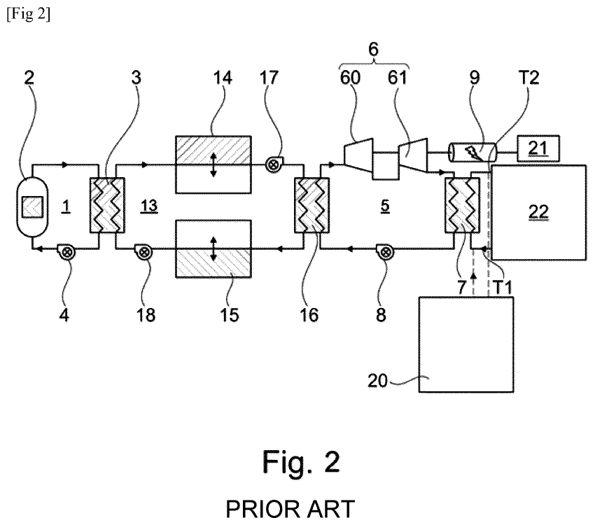

FIGS. 1 and 2 relating to the prior art have already been described in detail in the preamble and are therefore not commented on hereinafter.

For clarity, the same element according to the invention and to the prior art is designated by the same reference number in all of FIGS. 1 to 5.

There are not described again all the various relations and functions of elements common to a cogeneration installation according to the invention and a prior art cogeneration installation with a thermal storage loop as depicted in FIG. 2. Only some of the elements are described again.

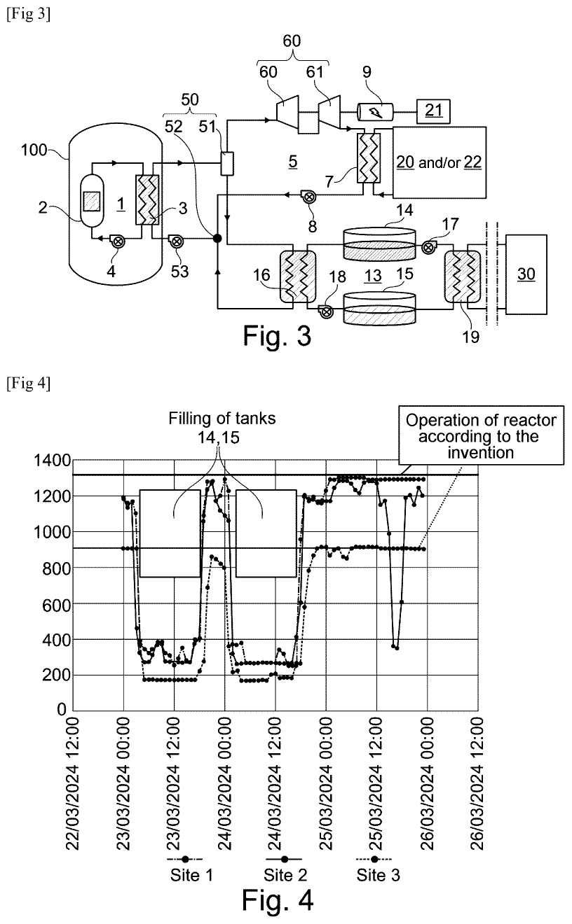

The nuclear cogeneration installation according to the invention depicted in FIG. 3 includes over and above the usual components of an installation with a usual PWR type reactor a thermal storage loop 13 thermally in parallel with the secondary circuit 5 of the reactor.

The thermal storage loop 13 is a closed loop fluidic circuit in which a heat transfer fluid circulates from a condenser 16 serving as an intermediate exchanger to a hot tank 14 and then into an outlet heat exchanger 19 and into a cold tank 15 in order to be returned to the condenser 16.

The heat transfer fluid is circulated in the loop 13 by a hydraulic pump 17 downstream of the hot tank 14 and a hydraulic pump 18 downstream of the cold tank 15.

The fluidic branches of the loop 13 each consist of a cylindrical section pipe with metal walls resistant to chemical aggression by the heat transfer fluid at high temperatures, typically above 300° C., and which is heat insulated on the exterior with a high-temperature insulation. The diameter of a pipe is calculated to enable evacuation of all the thermal power with an admissible maximum limit flowrate of the heat transfer fluid, typically of the order of 5 m/s to 10 m/s.

The hot tank 14 is for containing the heat transfer fluid to store all the heat recovered from the condenser 16 and for feeding the condenser 16 with heat transfer fluid. The hot tank 14 may be of cylindrical shape with walls made of metal resistant to chemical aggression by the heat transfer fluid at high temperatures, typically above 300° C., and is coated with an external high-temperature layer of insulation enabling limitation of heat losses. The dimensions (usable storage volume) of the hot tank 14 depend on the characteristics of the heat transfer fluid used and must enable it to store at most all of the heat produced by the nuclear reactor over a sliding period of 24 hours. For safety reasons the hot tank 14 is typically at a distance estimated beforehand of 60 m from the containment vessel of the reactor with a batter between them. The tank 14 can be equipped with a system for heating the heat transfer fluid to guarantee that the fluid remains in the liquid state and/or a level measuring system able to issue an alarm and/or a safety overflow connected directly to the cold tank 15.

The condenser 16 transfers the heat contained in the steam produced in the steam generator 3 to the heat transfer fluid in the loop. This intermediate exchanger 16 is a condenser because the steam coming from the steam generator 3 gives up its energy by condensing.

Like the hydraulic pump 18 the hydraulic pump 17 is designed to operate at least at the availability coefficient K_{d} of the nuclear reactor and must be able to accept fluctuations in the electricity demand of the grid 21 to which the alternator 9 of the nuclear reactor is electrically connected. The flowrate of the pump 17 or 18 must enable the steam generator 16 to be supplied with heat transfer fluid at a flowrate enabling it to respond to the power demand of the grid 21 given the calorific capacity of the heat transfer fluid and the dimensions of the steam generator 16. Each of the pumps 17, 18 has metal walls resistant to chemical aggression by the heat transfer fluid at high temperatures, typically above 300° C. A plurality of pumps 17 or 18 can be used in parallel to divide the pumping flowrate and for safety reasons a redundant pump can be provided.

The cold tank 15 has substantially the same storage volume for the heat transfer fluid recovered from the condenser 16 as the hot tank 14. The cold tank 15 can be of cylindrical shape with walls made of metal resistant to chemical aggression by the heat transfer fluid at high temperatures, typically above 300° C., and is coated with an external high-temperature layer of insulation enabling limitation of thermal losses. The dimensions (usable storage volume) of the cold tank 15 depend on the characteristics of the heat transfer fluid used and must enable it to store at most all of the heat produced by the nuclear reactor over a sliding period of 24 hours. For safety reasons the cold tank 15 is typically at a distance estimated beforehand of 60 m from the enclosure of the reactor with a batter between them. The tank 15 can be equipped with a system for heating the heat transfer fluid to guarantee that the fluid remains in the liquid state and/or a level measuring system able to issue an alarm and/or a safety overflow connected directly to the hot tank 14.

The outlet exchanger 19 transfers the heat contained in the heat transfer fluid from the loop 13 to the heat transfer fluid of an industrial heat (water) network 30. If the industrial heat network needs steam then this component 19 is a steam generator. Its dimensions depend on the characteristics of the heat transfer fluid used and must enable it to transfer at most all of the heat produced by the nuclear reactor over a sliding period of 24 hours. This duration could be adapted on a case-by-case basis as a function of the real implantation configurations and the requirements of the industrial heat network. At the outlet of the exchanger 19 the water or the steam for the network 30 can be heated to 240° C. The fluid conveyed can then be steam or super-heated water, given the nature of the industrial requirements.

The heat transfer fluid is of the molten salt type so as to remain in the liquid phase over a range of temperatures from 160° C. to 350° with a margin of 40° C. relative to the maximum temperature in operation. The salt preferably has the following chemical composition: 45% NaNO₂, 7% KNO₃, 48% Ca(NO₃)₂ (HITEC-XL salt).

The total volume of salt contained in the closed loop 13 is equal to the total volume of the cold tank 15 and the volume contained in the fluidic branches/pipes of the loop 13 to prevent any loading in operation.

The grid 21 connected to the alternator 9 is intended to transport and distribute electricity to end users as a function of their requirement. It is a high-tension grid functioning in accordance with the power demand linked to the uses of the electricity and must be able to accept the electrical power spike produced by the cogeneration installation.

The cogeneration installation includes at least one air-cooling tower 20 using dry air, that is to say functioning dry, connected in a closed loop to the condenser 7 of the secondary circuit of the reactor.

This air-cooling tower 20 transfers heat from the water condensed in the condenser 7 to the surrounding air.

The air-cooling tower 20 is sized to evacuate the thermal power not consumed by the turbines 6, 60, 61 by cooling the water fed from the condenser 7 and heating the surrounding air.

Although not represented, the closed loop including the condenser 7 and the dry air type air-cooling tower 20 is equipped with a pumping system for conveying the heat transfer fluid within it; this pumping system can be integrated directly into the tower 20.

The dry air type air-cooling tower 20 can be connected to bypass an atmospheric CO₂ capture system 22.

The entire cogeneration installation is typically and advantageously configured to obtain in the closed loop incorporating the condenser 7 and the atmospheric CO₂ capture system 22 a temperature T1 at the inlet of the condenser of at least 60° C. and a temperature T2 at the outlet of the condenser 7 of at least 70° C., advantageously between 70° C. and 100° C.

In accordance with the invention, a fluidic system 50 enables the secondary circuit 5 of the reactor to be thermally in parallel with the thermal storage loop 13.

This system 50 includes firstly a steam distribution and regulation device 51 connected at the inlet to the steam generator 3 and at the outlet to the turbine 6 and at the same time to the condenser 16 of the thermal storage loop. The function of this device 51 is therefore to distribute the steam produced by the generator 3 between the requirements for production of electricity (Rankine cycle 5) and production of heat (storage loop 3 in series with the heat network 50).

This steam distribution and regulation device 51 advantageously includes two motorized valves, one of which connects the steam generator 3 to the turbine 6 and the other of which connects the steam generator 3 to the condenser 16 in the thermal storage loop.

The system 50 also includes a water collection tank 52 connected at the inlet both to the condenser 7 in the circuit 5 and to the condenser 16 in the storage loop 13 and at the outlet to the steam generator 3. The function of this tank 52 is therefore to collect water arriving from the conversion cycle 5 and the condenser 16 in the loop 13 to return it to the steam generator 3. This tank 52 is preferably of cylindrical shape and pressurized to approximately 20 bar to withstand the pressure maintaining the temperature in the water circuit of the conversion cycle 5, the temperature of which is 150-200° C.

A pump 53 is disposed in the circuit connecting the water collecting tank 52 and the steam generator 3 to feed the latter with pressurized water. Like the pumps 17, 18 the pump 53 is designed to operate at least at the availability coefficient K_{d} of the nuclear reactor. The flowrate of the pump 53 must make it possible to evacuate all the thermal power from the reactor given the calorific capacity of the heat transfer fluid (water) and the temperature difference at the terminals of the steam generator 3. This pump 53 has metal walls resistant to chemical aggression by the heat transfer fluid at high temperatures, typically above 300° C. A plurality of pumps 53 can be used in parallel to distribute the pumping flowrate and a redundant pump can be provided for safety reasons.

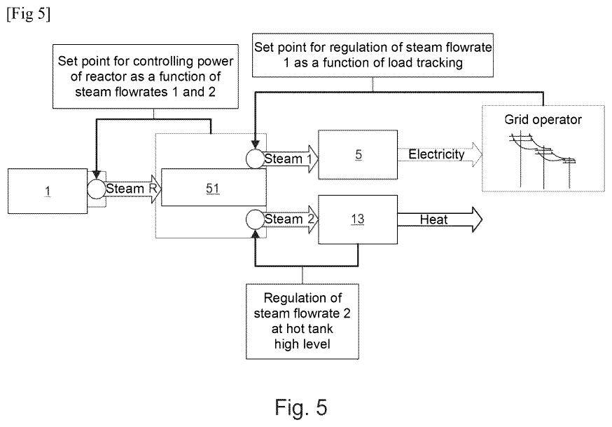

The operating principle of the installation depicted in FIG. 5 using such a system 50 is as follows:
the nuclear reactor functions in a nominal mode and the power is reduced only if the hot tank 14 has reached its high filling level,
the tanks 14, 15 are filled as the grid load is tracked.

Various technical configurations and operating modes of the installation according to the invention are possible.

FIG. 5 depicts a control method that makes it possible to maximize production by the nuclear reactor with:
priority assigned to the grid 21;
filling the thermal storage tanks;
on condition that, as long as the tanks have not reached a sufficient filling level, that could be to a first approximation of the order of 80%, then the power level of the reactor is adapted to track the electrical load.

In accordance with this control method the valve connecting the steam generator 3 to the turbine 6 is opened and closed according to regulation set points as a function of tracking the electrical load on the reactor. Opening and closing the valve connecting the steam generator 3 to the condenser 16 in the loop 13 are controlled in accordance with regulation set points as a function of the level in the hot tank 14.

The invention is not limited to the examples that have just been described; in particular features of examples depicted can be combined in variants that are not depicted.

Other variants and embodiments can be envisaged without departing from the scope of the invention.

In the example depicted the system 22 is a CO₂ capture system. However, there may equally be envisaged a seawater desalination system in addition to or instead of the CO₂ capture system.

The nuclear cogeneration installation that has just been described that uses a pressurized water nuclear reactor is entirely suitable for use with indirect thermodynamic cycle nuclear reactors in which the heat production cycle is physically separate from the energy conversion cycle. Thus a reactor of the second, third, fourth generation (GEN IV) can be envisaged. This applies in particular to fast neutron nuclear reactors cooled by liquid metal, notably liquid sodium, or sodium fast reactors (SFR) that are part of the GEN IV reactor family.

Installations with one or more SMR type reactors, in particular of PWR type, can respond to the decarbonization requirements of industry. At this time most industrial sites (such as chemical industry sites) use fossil fuels and are not adopting a decarbonization and elimination of fossil fuels approach.

Small modular reactors can have a role in addressing these objectives by supplying at the same time electricity and heat at the temperature level that they are able to service modulo pinch effects of exchangers serving as barriers, that is to say approximately 300° C. for a PWR, approximately 500° C. for a fast neutron reactor, 600° C. for a molten salt reactor (MSR) and 750° C. for a high temperature reactor (HTR).

In other words, installing an SMR functioning in electricity/heat cogeneration mode at 300° C. in accordance with the invention would make it possible to respond to decarbonization of all or part of a petrochemical site.

Equipping petrochemical sites producing molecules of interest such as olefins, methanol and polymers with a cogeneration installation according to the invention can be envisaged.

### LIST OF REFERENCES CITED

[1]: “Améliorer l'efficacité énergétique en utilisant la cogénération dans la production d'électricité” Jean-Marie Loiseaux, Henri Safa, Bernard Tamain, Réseau Sauvons le Climat.
[2]: Rapport Carbon 4—November 2022—Chaleur renouvelable: la grande oubliée de la stratégie énergétique française.
[3]: International Energy Agency—CO2 emissions in 2022.
[4]: EUROPAIRS End User Requirement for Process heat applications with Innovative Reactors for Sustainable energy supply.
[5]: Nuclear cogeneration: civil nuclear energy in a low-carbon future, The Royal Society, UK.

1. An electronuclear cogeneration installation comprising:
at least one nuclear reactor, in particular a pressurized water reactor (PWR) or a boiling water reactor (BWR) comprising:
a first fluidic circuit, termed the primary circuit, comprising at least one steam generator serving as a first intermediate heat exchanger;
a second fluidic circuit, termed the secondary circuit, comprising at least one turbine connected to the first intermediate heat exchanger and a first condenser connected to the turbine and to the steam generator to cool the steam from the turbine and to convert it back into water and return it into the steam generator;
an alternator mechanically coupled to the turbine and intended to be connected to a grid;
a third fluidic circuit configured as a closed thermal energy storage loop in which a heat exchanger fluid circulates, comprising:
at least one second condenser serving as a second intermediate heat exchanger;
at least one output heat exchanger connected in a closed loop to an industrial heat network;
at least one first tank, termed the hot tank, connected to the second condenser;
at least one first hydraulic pump connected to the hot tank and to the output heat exchanger;
at least one second tank, termed the cold tank, connected to the output heat exchanger;
at least one second hydraulic pump connected to the cold tank and to the second condenser;
a fluidic system for connecting thermally in parallel the third fluid circuit and the second fluidic circuit.

2. The cogeneration installation as claimed in claim 1, the fluidic system for connecting thermally in parallel the third fluidic circuit and the second fluidic circuit comprising:
a steam distribution and regulation device connected at the input to the steam generator and at the output to the turbine and at the same time to the second condenser;
a water collecting tank connected at the inlet to the first condenser and at the same time to the second condenser and at the outlet to the steam generator;
a third pump connected between the water collecting tank and the steam generator.

3. The cogeneration installation as claimed in claim 2, the steam distribution and regulation device comprising two motorized regulation valves one of which connects the steam generator to the turbine and the other of which connects the steam generator to the second condenser.

4. The cogeneration installation as claimed in claim 3, opening and closing the valve connecting the steam generator to the turbine being controlled in accordance with regulation set points as a function of reactor load tracking whereas opening and closing the valve connecting the steam generator to the second condenser are controlled in accordance with regulation set points as a function of the level in the hot tank.

5. The cogeneration installation as claimed in claim 2, the temperature of the water in the collecting tank being between 150° C. and 200° C.

6. The cogeneration installation as claimed in claim 1, the reactor containment vessel and the steam generator being configured as a small modular reactor (SMR).

7. The cogeneration installation as claimed in claim 1, further comprising at least one atmospheric carbon dioxide CO₂ capture system and/or seawater desalination system or any other cogeneration system with a heat demand compatible with the temperature at the terminals of the condenser connected in a closed loop to the condenser of the secondary circuit of the reactor.

8. The cogeneration installation as claimed in claim 7, further comprising a dry air air-cooling device connected to bypass a connection to the carbon dioxide CO₂ capture system or seawater desalination system.

9. The cogeneration installation as claimed in claim 8, the dry air air-cooling device being a dry air air-cooling tower.

10. The cogeneration installation as claimed in claim 1, the temperature T1 at the inlet of the condenser being at least 60° C. and the temperature T2 at the outlet of the condenser being at least 70° C., advantageously between 70° C. and 100° C.

11. The cogeneration installation as claimed in claim 1, each of the hot and cold tanks having a volume between 1000 m³ and 30 000 m³.

12. The cogeneration installation as claimed in claim 1, the heat transfer fluid in the thermal storage loop being a molten salt or a mixture of molten salts adapted to remain in the liquid phase over a range of temperatures from 100° C. to 350° C. with a margin of 40° C. relative to the maximum temperature in operation of the thermal storage loop.

13. The cogeneration installation as claimed in claim 1, the turbine or turbines having no low-pressure body.
